(19) United States
(12) Patent Application Publication
(10) Pub. No.: US 2012/0140680 A1
(43) Pub. Date: Jun. 7, 2012

(54) Ring-tone Detection in a VoIP Call

(75) Inventors: Paul Basil French, Dublin Pike (IE); Fred Raguillat, Dunboyne (IE); Eric Thiebaut-George, Donnybrook (IE)

(73) Assignee: INTERNATIONAL BUSINESS MACHINES COMPANY, Armonk, NY (US)

(21) Appl. No.: 12/959,927

(22) Filed: Dec. 3, 2010

(51) Int. Cl. H04L 12/16

(52) U.S. Cl. 370/259

(57) ABSTRACT

Alerting a calling party in a Voice over IP (VoIP) setting that a called party might not be able to hear ring-tones. In response to a call arriving on an IP connection, the audible level of ring-tones that are generated by a microphone associated with a VoIP computer application is sampled, and responsive to the audible level of ring-tones being below a minimum threshold, a message is transmitting to the calling party via any available connection that the called party might be unable to hear the ring-tones.

### TECHNICAL FIELD

The invention relates to telephony in general and especially to detecting conditions at a called party location that can interfere with satisfactory communication in a voice over IP setting.

### BACKGROUND OF THE INVENTION

Communication has always been a key element of our society, and even more so in present time where communication is required to be nearly instant. Over time, types of communications have evolved, traditional remote telecommunication is progressively being replaced by internet based communications, and today 80% of the new generation of home-users use the traditional phone less, switching to more interactive types of communication that embrace technology such as VoIP that provides audio & video components at a cheaper cost than traditional telephony methods. VoIP technology is becoming more accessible and sometimes as a free service across the globe. VoIP is proposed as part of internet packages offered by service providers as a competitive argument. From a business point of view VoIP technology is also very important, as more & more company employees are able to work remotely in the comfort of their own home. Thus, internet services such as VoIP are important, especially when users need to communicate one-to-one1 or to participate in teleconferences, which often require audio or video services. In both cases, private & company users, depend on good functionalism of their computer devices to see and hear properly. The invention focuses on the audibility function in addressing the problem of muted, low level or disabled audio devices and noisy environments when incoming VoIP calls are received at a called party location. Users are often not in front of their computer screens even if their computers are operating; in such cases, they rely on an audible sound (a ring-tone) to be notified of incoming calls. However, the computer sometimes cannot play ring-tones. This can happen for different reasons; for example, 1. the sound system has been switched off, or the volume lowered or muted, 2. sound has been redirected to a headset, 3. the called party location might be excessively noisy.

In these cases, if a called party happens to be away from the computer, he or she will not be able to hear the ring-tones of an incoming VoIP call. A calling party is also unaware of such conditions at the called party location and will probably respond inappropriately, such as continued ringing or repeated calls. The invention can be especially important for urgent incoming calls when ring-tones cannot be heard.

### SUMMARY OF THE INVENTION

A first embodiment is a method for alerting a calling party in a Voice over IP (VoIP) call that a called party might not be able to hear ring-tones. At a called party location, in response to a call arriving on an IP connection, the audible level of ring-tones that are generated by a microphone associated with a VoIP computer application is sampled. Responsive to the audible level of ring-tones generated by the microphone being below a minimum threshold, a message is transmitted to the calling party via any available connection that the called party might be unable to hear the ring-tones.

A second embodiment is a computer program product having a storage medium containing computer instructions for controlling a computer to alert a calling party in a Voice over IP (VoIP) call that a called party might not be able to hear ring-tones. Responsive to a call arriving on an IP connection, the audible level of ring-tones that are generated by a microphone associated with a VoIP computer application is sampled. Computer instructions responsive to an audible level of ring-tones generated by the microphone being below a minimum threshold transmit a message to the calling party via any available connection that the called party might be unable to hear the ring-tones.

A third embodiment is a system for alerting a calling party in a Voice over IP (VoIP) call that a called party might not be able to hear ring-tones. The system comprises a computer attached to an incoming IP connection. The computer is responsive to a call arriving on the IP connection for sampling the audible level of ring-tones that are generated by a microphone associated with a VoIP computer application. The computer is responsive to an audible level of ring-tones generated by the microphone being below a minimum threshold for transmitting a message to the calling party via any available connection that the called party might be unable to hear the ring-tones.

The above as well as additional objects, features, and advantages of the present invention will become apparent in the following detailed written description.

### BRIEF DESCRIPTION OF THE DRAWING

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 shows an illustrative computer screen of a VoIP application running in a computer at a called party location;

FIGS. 2 and 3 show an illustrative flowchart of steps that might be performed by the VoIP application in response to an incoming call;

FIG. 4 shows an illustrative flowchart of a portion of the VoIP application that responds to actions of a user with the screen of FIG. 1; and

FIG. 5 is an illustrative block diagram of components of a computer that could be used to practice the invention.

### DETAILED DESCRIPTION

As will be appreciated by one skilled in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus or device. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The computer program instructions can be stored as computer instructions in a remote data processing system and downloaded over a network from the remote data processing system.

The computer program instructions can be stored in a server data processing system and downloaded over a network to a remote data processing system for use in a computer readable storage medium with the remote system.

A “Voice over IP” (VoIP) application lets two users talk to each other through a network (usually the internet) by using a microphone and a sound system (speakers, headsets, external sound systems), either connected to their computer, or embedded therein, as is the case of most computer mobile devices. A first user (a caller) calls another user (a called party) by usually selecting the called party's name in the application and then selecting “phone call” or “video call”. The called party's computer usually displays a window with a visible message on the computer screen, and plays an audible sound (usually called a ring-tone). Assuming that the called party is present, he or she sees or hears the alert and accepts the incoming call.

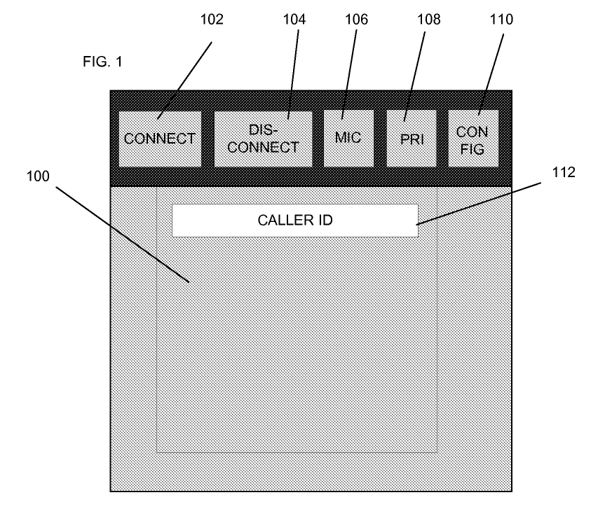

FIG. 1 shows some illustrative details that might be displayed on a computer screen of a VoIP application being run by a computer. At the top of FIG. 1 there might be a series of iconic buttons that a user might use to direct and configure the VoIP application. For example, a CONNECT button 102 can be used to initiate an outgoing, a DISCONNECT button 104 can be used to disconnect from a call, a MIC button 106 can be used to enable or disable a microphone, a PRI button 106 can be used to disable the monitoring of ring-tones and local noise through the microphone if the user is concerned about privacy, and a CONFIG button can be used to configure other functions of the VoIP application. A caller ID field 112 might be present to identify a calling party by name or other means. Typically, there is no CONNECT button. One can just double click on a recipient name.

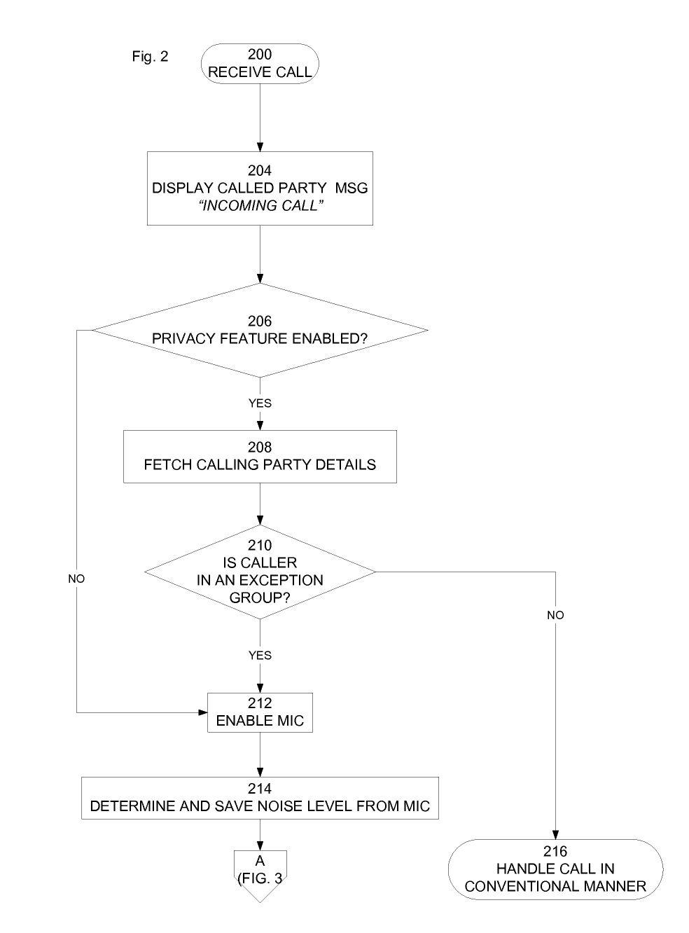

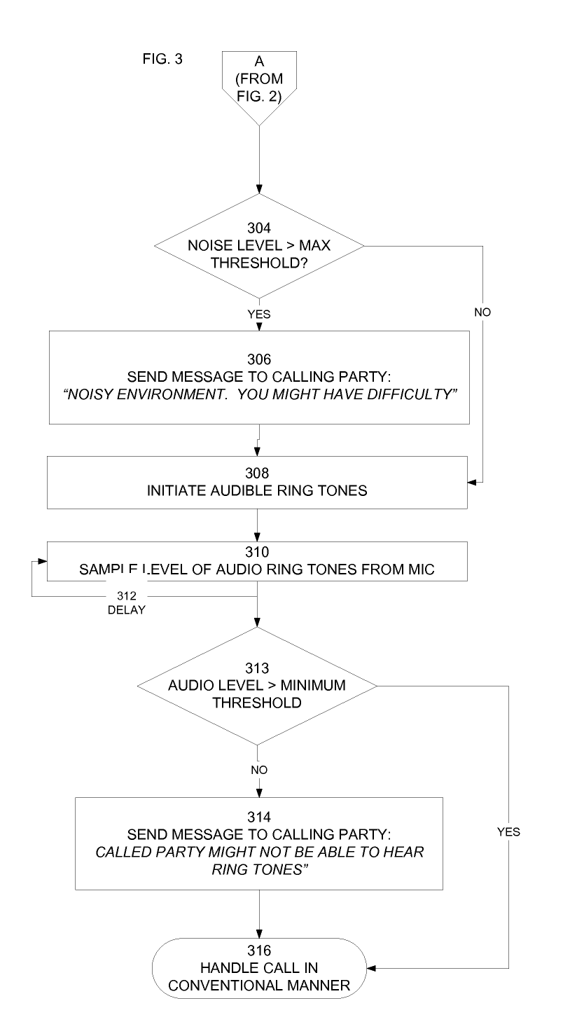

FIGS. 2 and 3 illustrate illustrative steps performed by the VoIP application in response to an incoming call. The call is received at 200. Step 204 displays a message on the called party's screen identifies the incoming call and might identify the calling party in the ID field 112 of FIG. 1. Step 206 determines if the user at the called party location has enabled a privacy feature that disables the monitoring of ring-tones or location noise coming through the microphone. If the privacy feature is not enabled, step 212 ensures that the microphone is enabled. If the privacy feature is enabled, then step 208 determines from a configuration file if the calling party is identified as an exception to the privacy feature. For an example, a user might generally want the privacy feature enabled, but still wish to disable the privacy feature for emergency calls or calls from select people. Step 210 determines from the incoming calling party identification and the configuration file if the calling party is identified as an exception to the disablement of the privacy feature. If the answer at 212 is yes, the local microphone is enabled by step 212. This is achieved by using an API conventionally provided by VoIP service providers. The same API can be used to monitor audio levels received by the microphone, as discussed below. If the answer is no at 212, the microphone is left disabled and the remainder of the call is handled in a conventional manner, as stated at step 216. Assuming that the microphone is enabled, step 214 monitors the sound coming from it to determines and saves a measure of the level of noise in the vicinity of the VoIP computer. The VoIP application then continues at “A” of FIG. 3.

Step 304 of FIG. 3 determines if the noise level measured at step 214 exceeds a threshold level. If not, processing continues at step 308. If the noise level is high, the VoIP application at step 306 generates and sends an alert message over the IP connection to the calling party that the local environment is noisy. Processing of the call preferably continues at step 308 where the VoIP application initiates ring-tones through the local sound system. Step 310 samples the audio level of the ring-tones heard by the microphone. Sampling might occur more than once, as indicated at 312. When sampling is complete, step 313 compares the sampled ring-tone audio level to a minimum threshold. Preferably, the minimum threshold of step 313 is relative to the noise sampled in step 214. If the audio level is less that the minimum threshold, then step 314 generates and sends a message to the calling party that the called party might not be able to hear the ring-tones. Alternatively, it might compare the audio level to the previously-collected ambient noise level, and insures that the new level is at least equal to the old_level+threshold. Messages sent to a calling party can be sent via any available connection, such as email or instant messaging. Preferably, the incoming IP connection is used to send messages to a calling party. Irrespective of the sampled ring-tone level, processing of the call is now handled in a conventional manner, as indicated at step 316.

There are numerous known methods for determining the characteristics of audible signals such as ring-tones and audible noise. One example that uses a Fourier transform method is disclosed in United States Patent Application 20090157391, entitled “Extraction and Matching of Characteristic Fingerprints from Audio Signals”. Another example is U.S. Pat. No. 4,028,496, entitled “Digital speech detector” uses average peak levels attained during intervals of speech. Known methods can include coarse-level “volume” checks, or fine-grained frequency matching.

Other variations of the disclosed embodiment can also be easily implemented by workers skilled in the art. For example, the ambient noise level can be compared with an expected level of ring-tone to distinguish ringtone from background noise. The incoming noise, frequencies or level before the ringtone is initiated can be compared with these characteristics as ring-tone is generated to notify a caller that the called party may not hear the ring-tone because of background noise.

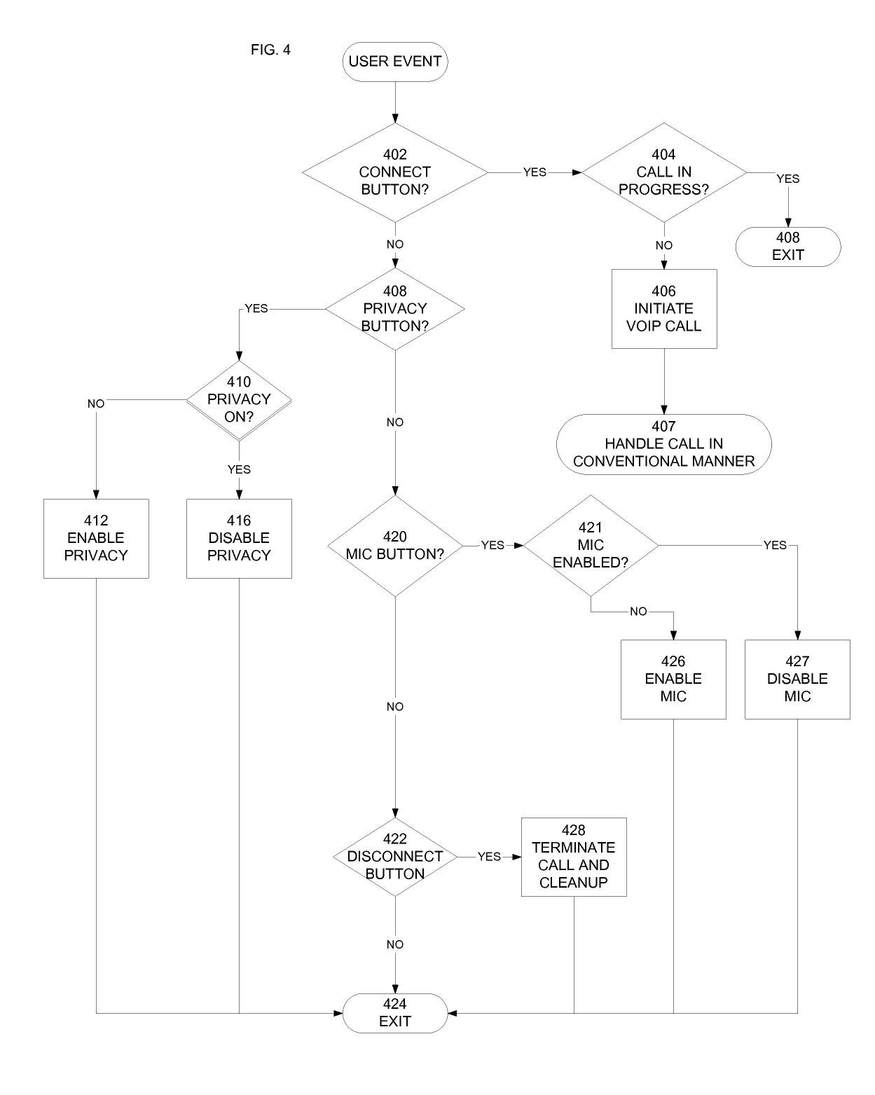

FIG. 4 shows illustrative steps that the VoIP application might perform in response to user interactions with the screen of FIG. 1. Step 402 determines if the user has clicked on the CONNECT button, If yes, step 404 determines if a call is already in progress and ignores the event if yes. Otherwise, steps 406 and 407 initiate an outgoing VoIP call in a conventional manner.

Step 408 determines if the PRI (privacy) button has been clicked. If yes, steps 410, 412 and 416 toggles the present state of the privacy feature in a user configuration file.

Step 420 determines if the MIC (microphone) button has been clicked. If so, steps 421, 426 and 427 toggle the enable/disable state of the local microphone in the configuration file.

Steps 422 and 428 terminate a call in a conventional manner if the DISCONNECT button has been clicked.

Other conventional features that are usually present, but not discussed in any detail, are assumed to be present. For example, it is expected that a means for a user to add names or other identification to a privacy exception list in the configuration file or other file is available.

If plural microphones are available (e.g. main microphone and headset microphone), the VoIP application might let the user configure which one is used for sound monitoring. As an alternative to a privacy feature, a volume detector device (e.g. decibel meter) could monitor ambient volume level. This device can only detect audio levels as opposed to sounds and should relieve users who are concerned with privacy.

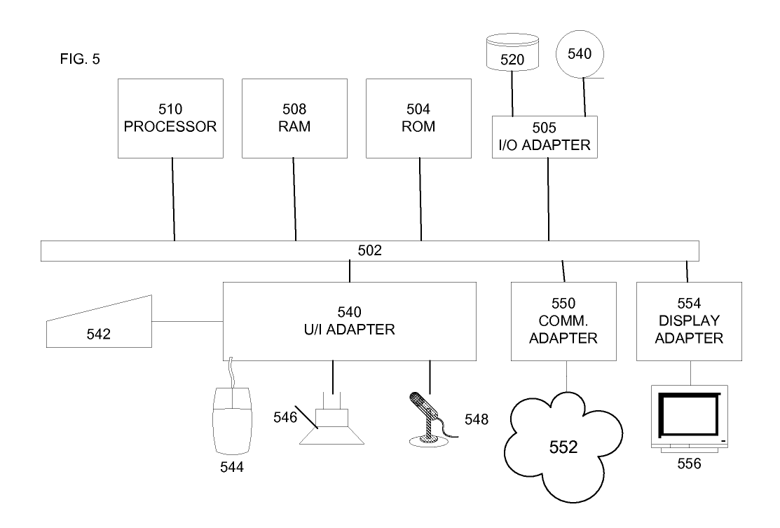

FIG. 5 illustrates a simplified example of an information handling system that may be used to practice the present invention. The invention may be implemented on a variety of hardware platforms, including embedded systems, personal computers, workstations, servers, and mainframes. The computer system of FIG. 5 has at least one processor 510. Processor 510 is interconnected via system bus 502 to random access memory (RAM) 508, read only memory (ROM) 504, and input/output (I/O) adapter 505 for connecting peripheral devices such as disk unit 520 and tape drive 540 to bus 502. The system has user interface adapter 540 for connecting keyboard 542, mouse 544, or other user interface devices such as audio output device 546 and audio input device 548 to bus 502. The system has communication adapter 550 for connecting the information handling system to a data processing network 552, and display adapter 554 for connecting bus 502 to display device 556. Communication adapter 550 may link the system depicted in FIG. 5 with hundreds or even thousands of similar systems, or other devices, such as remote printers, remote servers, or remote storage units. The system depicted in FIG. 5 may be linked to both local area networks (sometimes referred to as intranets) and wide area networks, such as the Internet.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described to best explain the principles of the invention and the practical application, and to enable others of ordinary skill in the art to understand the invention for various embodiments with various modifications as are suited to the particular use contemplated. Having thus described the invention of the present application in detail and by reference to preferred embodiments thereof, it will be apparent that modifications and variations are possible without departing from the scope of the invention defined in the appended claims.

We claim:

1. A method of alerting a calling party in a Voice over IP (VoIP) call that a called party might not be able to hear ring-tones, comprising
at a called party location, in response to a call arriving on an IP connection, sampling the audible level of ring-tones that are generated by a microphone associated with a VoIP computer application, and
responsive to the audible level of ring-tones generated by the microphone being below a minimum threshold, transmitting a message to the calling party via any available connection that the called party might be unable to hear the ring-tones.

2. The method of claim 1 further comprising
sampling the level of audio ring tones generated by the microphone,
comparing the level of audio ring tones generated by the microphone to a maximum threshold, and
transmitting a noisy environment message to the calling party over any available connection.

3. The method of claim 1 or claim 2 wherein an available connection can be the IP connection.

4. The method of claim 1 or claim 2 wherein an available connection can be an email connection.

5. The method of claim 1 or claim 2 wherein an available connection can be an instant messaging connection.

6. A computer program product having a storage medium containing computer instructions for controlling a computer to alert a calling party in a Voice over IP (VoIP) call that a called party might not be able to hear ring-tones, comprising
computer instructions, responsive to a call arriving on an IP connection for sampling the audible level of ring-tones that are generated by a microphone associated with a VoIP computer application, and
computer instructions responsive to an audible level of ring-tones generated by the microphone below a minimum threshold for transmitting a message to the calling party via any available connection that the called party might be unable to hear the ring-tones.

7. The computer program product of claim 6 further comprising
computer instructions for sampling the level of audio ring tones generated by the microphone,
computer instructions for comparing the level of audio ring tones generated by the microphone to a maximum threshold, and
computer instructions for transmitting a noisy environment message to the calling party over any available connection.

8. The computer program product of claim 6 or claim 7 wherein an available connection can be the IP connection.

9. The computer program product of claim 6 or claim 7 wherein an available connection can be an email connection.

10. The computer program product of claim 6 or claim 7 wherein an available connection can be an instant messaging connection.

11. A system for alerting a calling party in a Voice over IP (VoIP) call that a called party might not be able to hear ring-tones, comprising
at a called party location, a computer attached to an incoming IP connection,
the computer being responsive to a call arriving on the IP connection for sampling the audible level of ring-tones that are generated by a microphone associated with a VoIP computer application, and
the computer being responsive to an audible level of ring-tones generated by the microphone below a minimum threshold for transmitting a message to the calling party via any available connection that the called party might be unable to hear the ring-tones.

12. The system of claim 11 further comprising
the computer sampling the level of audio ring tones generated by the microphone,
the computer comparing the level of audio ring tones generated by the microphone to a minimum threshold, and
the computer transmitting an alert message to the calling party over any available connection.

13. The system of claim 11 or claim 12 wherein an available connection can be the IP connection.

14. The system of claim 11 wherein an available connection can be an email connection.

15. The system of claim 11 or claim 12 wherein an available connection can be an instant messaging connection.

16. The computer program product of claim 5, wherein the program instructions are stored in a data processing system, and wherein the instructions are downloaded over a network from a remote data processing system.

17. The computer program product of claim 5, wherein the program instructions are stored in a server data processing system, and wherein the instructions are downloaded over a network to a remote data processing system for use in a computer readable storage medium with the remote system.
